(19) United States
(12) Patent Application Publication
(10) Pub. No.: US 2024/0310261 A1
(43) Pub. Date: Sep. 19, 2024

(54) AUTOMATED SYSTEM FOR FLUID QUALITY INSIDE THE IMPULSE LINE DIFFERENTIAL PRESSURE TRANSMITTER FOR INTERFACE LEVEL MEASUREMENT AND METHOD OF USE

(71) Applicant: SAUDI ARABIAN OIL COMPANY, Dhahran (SA)

(72) Inventors: Faleh M. Dossary, Al Hofuf (SA); Ray V. Gonzales, Udhailiyah (SA); Mohammad Bograin, Al Hofuf (SA)

(73) Assignee: SAUDI ARABIAN OIL COMPANY, Dhahran (SA)

(21) Appl. No.: 18/183,834

(22) Filed: Mar. 14, 2023

(51) Int. Cl. G01N 9/26

(52) U.S. Cl. CPC G01N 9/26

(57) ABSTRACT

A system for measurement of an interface level of a vessel contains high-density and low-density immiscible fluids in a vessel high side and a vessel low side. The system includes a controller configured to receive operational parameters of impulse line fluids in a first and a second impulse line. The system also includes a first density sensor coupled to the vessel high side and a second density sensor coupled to the vessel low side. The first and second density sensors transmit to the controller a first set and a second set of operational parameters of the high-density and low-density fluids. The controller determines the measurement of the interface level of the vessel using the first set and the second set of operational parameters and communicates the interface level to a user device. The system then executes an impulse line flushing method based on an input from the user device.

### BACKGROUND

Vessels containing two immiscible fluids with different fluid densities may have a horizontal interface between the two fluids inside the vessel. Two or more immiscible fluids with different densities may have more than one interface. An interface level reflects the relative position of the interface with respect to a reference point such as the bottom of the vessel. The interface level may be determined by measuring the hydrostatic head pressure differential between the fluids located above and below the interface. The pressure differential is typically measured by an instrument hydraulically connected to the two fluids at the vessel wall.

The instrument may use impulse lines to connect to the two different fluids. The fluids within the impulse lines represent the fluids in the vessel, however, over time may become stagnant and/or contaminated and the integrity of the value of the pressure differential may be impacted by the stagnation. Accordingly, it is necessary to rehabilitate the fluids in the impulse lines from time to time in order to restore the fluid quality to confirm the pressure differential at the instrument accurately reflects the fluid densities in the vessel.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

This disclosure presents, in accordance with one or more embodiments methods and systems for a system for measurement of an interface level of a vessel containing a high-density immiscible fluid in a vessel high side and a low-density immiscible fluid in a vessel low side. The system includes a controller disposed in a gas-oil separation environment. The controller is configured to receive operational parameters of impulse line fluids. The impulse line fluids include a first impulse line fluid in a first impulse line and a second impulse line fluid in a second impulse line. The system also includes a first density sensor coupled to the vessel high side and a second density sensor coupled to the vessel low side. The first density sensor is configured to transmit a first set of operational parameters of the high-density immiscible fluid to the controller. The second density sensor is configured to transmit a second set of operational parameters of the low-density immiscible fluid to the controller. The controller is configured to perform determining the measurement of the interface level of the vessel using the first set of operational parameters and the second set of operational parameters. The controller also performs communicating the interface level to a user device and executing a flushing method based on an input from the user device.

In some aspects, the techniques described herein relate to a method for a measurement of an interface level of a vessel containing a high-density immiscible fluid in a vessel high side and a low-density immiscible fluid in a vessel low side. The method includes disposing a controller in a gas-oil separation environment and the controller receiving operational parameters of impulse line fluids. The impulse line fluids include a first impulse line fluid disposed in a first impulse line and a second impulse line fluid disposed in a second impulse line. The method also includes coupling a first density sensor to a vessel high side and coupling a second density sensor to a vessel low side, then transmitting a first set of operational parameters of the high-density immiscible fluid to the controller and transmitting a second set of operational parameters of the low-density immiscible fluid to the controller. The method also includes determining the measurement of the interface level of the vessel using the controller, the first set of operational parameters, and the second set of operational parameters and then using the controller to communicate the interface level to a user device. The method also includes performing a flushing method based on an input from the user device.

Other aspects and advantages of the claimed subject matter will be apparent from the following description and the appended claims.

### BRIEF DESCRIPTION OF DRAWINGS

FIGS. 1, 2, 3, 4, and 5 show systems in accordance with one or embodiments.

FIGS. 6 and 7 show examples in accordance with one or more embodiments.

FIG. 8 depicts a flowchart in accordance with one or more embodiments.

FIG. 9 shows a computer system in accordance with one or more embodiments.

### DETAILED DESCRIPTION

Interface levels of immiscible fluids in closed vessels may be measured using an impulse line differential pressure transmitter using wet leg application. In a typical application the differential pressure transmitter is connected to the vessel through impulse lines high side (Water) and low side (Crude Oil), which allow the sensing element inside the differential pressure (DP) transmitter to measure and provide the exact interface level in the vessel based on the calibration range.

The vessel interface level measurement provided by the technique of using the differential pressure transmitter coupled to impulse lines has several known failure modes resulting in problems that can lead to an incorrect measurement. The problems only can be solved and fixed through routine maintenance, e.g., every six months or through emergency maintenance. For example, some problems with the impulse lines technique that may require the maintenance of rehabilitating the fluids in the impulse line from time to time include: stagnation of fluid in the impulse line for both low and high side result in inaccurate measurements; fluid in the impulse lines is different in specification from the fluid in the vessel; the fluid in the impulse lines “Low side (Crude Oil)” becomes contaminated with water or other impurities. The crude oil may contain molecules of water and the oil-water mixture in the impulse line may separate to form emulsion and foaming which may affect the level interface reading; and a weather change of volatile atmosphere affects the components of fluid in the impulse line.

The present interface level measurement application using a differential pressure transmitter in SGPD GOSPs (South Ghawar Producing Department Gas-Oil Separation Plants) is based on a number of severities such as transmitter malfunctions, inaccurate level measurement, and process upsets. A leading cause of the aforementioned problems is the stagnation of fluid in the impulse process line, which leads to differences in specification of the measured fluid in the impulse line vs. the fluid in the vessel. In order to obtain the best result, the fluid in both the impulse line and the vessel should be equal in all characteristics, qualities and viscosity, i.e., the fluid compositions consisting essentially of the same properties. A result of the level indicator control not working properly is that the interface level control loop will be operated in manual mode very often and all the time for long durations, which may lead to process upset, trips, and inaccurate level separation.

Embodiments herein disclose a system and method to automate and maintain the fluid quality in the impulse lines of the differential pressure transmitters interface level application by combining density sensing devices with a simple logic program that gives outputs to control and reintroduce the fluid in the impulse lines of DP level applications.

In use the two density sensors on the differential pressure transmitter impulse lines (high side-low side) continuously read the fluid density in the impulse lines. These data are sent as an input to the distributed control system (DCS). The DCS will automatically send an indicative signal to the operator (a user) and will shift the interface level control mode from auto mode (automatic mode) to manual mode. This alert will inform the operator (a user) to monitor and control the interface level in the vessel until the system finishes performing the method for flushing the impulse lines and returns the level control mode from the manual mode to auto mode again.

Based on the stated challenges, embodiments herein disclose an automated system that performs continuous monitoring of the impulse line fluid density of interface level applications. In the event that the monitored fluid densities in the impulse lines fail to meet acceptance criteria such as reference set points, then the DCS will perform an automated sequence of actions including changing the level control mode, flushing and draining the fluid in both impulse lines, refreshing the fluids in the impulse lines, and returning the level control to service.

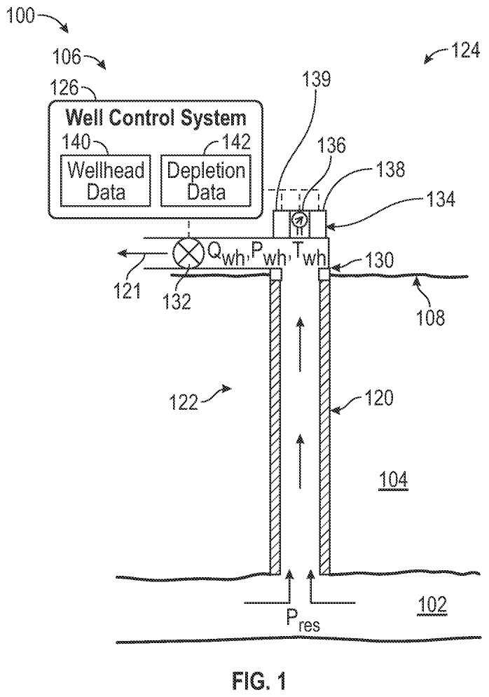

FIG. 1 shows a schematic diagram in accordance with one or more embodiments. As shown in FIG. 1. FIG. 1 illustrates a well environment 100 that includes a hydrocarbon reservoir (a reservoir 102) located subsurface in a hydrocarbon-bearing formation 104 and a well system 106. The hydrocarbon-bearing formation 104 may include a porous or fractured rock formation that resides underground, beneath the surface 108 of the earth. In the case of the well system 106 being a hydrocarbon well, the reservoir 102 may include a portion of the hydrocarbon-bearing formation 104. The hydrocarbon-bearing formation 104 and the reservoir 102 may include different layers of rock having varying characteristics, such as varying degrees of permeability, porosity, and resistivity. In the case of the well system 106 being operated as a production well, the well system 106 may facilitate the extraction of hydrocarbons (known as production) from the reservoir 102.

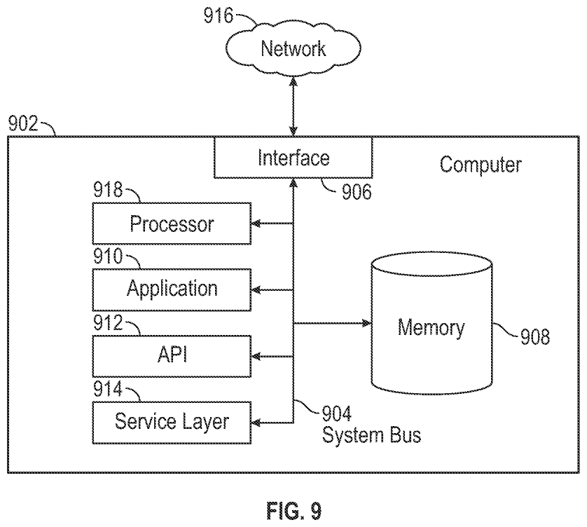

In some embodiments, the well system 106 includes a wellbore 120, a well sub-surface system 122, a well surface system 124, and a control system 126 for the well. The control system 126 may control various operations of the well system 106, such as well production operations, well completion operations, well maintenance operations, and reservoir monitoring, assessment, and development operations. In some embodiments, the control system 126 includes a computer system that is the same as or similar to that of the computer system (a computer 902) described below in FIG. 9 and the accompanying description.

The wellbore 120 may include a bored hole that extends from the surface 108 into a target zone of the hydrocarbon-bearing formation 104, such as the reservoir 102. An upper end of the wellbore 120, terminating at or near the surface 108, may be referred to as the “up-hole” end of the wellbore 120, and a lower end of the wellbore, terminating in the hydrocarbon-bearing formation 104, may be referred to as the “down-hole” end of the wellbore 120. The wellbore 120 may facilitate the circulation of drilling fluids during drilling operations, the flow of hydrocarbon production (production 121) (e.g., oil and gas) from the reservoir 102 to the surface 108 during production operations, the injection of substances (e.g., water) into the hydrocarbon-bearing formation 104 or the reservoir 102 during injection operations, or the communication of monitoring devices (e.g., logging tools) into the hydrocarbon-bearing formation 104 or the reservoir 102 during monitoring operations (e.g., during in situ logging operations).

In some embodiments, during operation of the well system 106, the control system 126 collects and records wellhead data 140 and depletion data 142 for the well system 106. The wellhead data 140 may include, for example, a record of measurements of wellhead pressure (P) (e.g., including flowing wellhead pressure (FWHP)), wellhead temperature (T) (e.g., including flowing wellhead temperature), wellhead production rate (Q) over some or all of the life of the well system 106, and water cut data. In some embodiments, the measurements are recorded in real-time, and are available for review or use within seconds, minutes or hours of the condition being sensed (e.g., the measurements are available within 1 hour of the condition being sensed). In such an embodiment, the wellhead data 140 may be referred to as real-time wellhead data. Real-time wellhead data may enable an operator of the well system 106 to assess a relatively current state of the well system 106, and make real-time decisions regarding development of the well system 106 and the reservoir 102, such as on-demand adjustments in regulation of production flow from the well.

With respect to water cut data, the well system 106 may include one or more water cut sensors. For example, a water cut sensor may be hardware and/or software with functionality for determining the water content in oil, also referred to as “water cut.” Measurements from a water cut sensor may be referred to as water cut data and may describe the ratio of water produced from the wellbore 120 compared to the total volume of liquids produced from the wellbore 120. Water cut sensors may implement various water cut measuring techniques, such as those based on capacitance measurements, Coriolis effect, infrared (IR) spectroscopy, gamma ray spectroscopy, and microwave technology. Water cut data may be obtained during production operations to determine various fluid rates found in production from the well system 106. This water cut data may be used to determine water-to-gas information regarding the wellhead 130.

In some embodiments, a water-to-gas ratio (WGR) is determined using a multiphase flow meter. For example, a multiphase flow meter may use magnetic resonance information to determine the number of hydrogen atoms in a particular fluid flow. Since oil, gas and water all contain hydrogen atoms, a multiphase flow may be measured using magnetic resonance. In particular, a fluid may be magnetized and subsequently excited by radio frequency pulses. The hydrogen atoms may respond to the pulses and emit echoes that are subsequently recorded and analyzed by the multiphase flow meter.

In some embodiments, the well surface system 124 includes a wellhead 130. The wellhead 130 may include a rigid structure installed at the “up-hole” end of the wellbore 120, at or near where the wellbore 120 terminates at the surface 108 of the Earth. The wellhead 130 may include structures for supporting (or “hanging”) casing and production tubing extending into the wellbore 120. Production 121 may flow through the wellhead 130, after exiting the wellbore 120 and the well sub-surface system 122, including, for example, the casing and the production tubing. In some embodiments, the well surface system 124 includes flow regulating devices that are operable to control the flow of substances into and out of the wellbore 120. For example, the well surface system 124 may include one or more of a production valve 132 that are operable to control the flow of production 121. For example, a production valve 132 may be fully opened to enable unrestricted flow of production 121 from the wellbore 120, the production valve 132 may be partially opened to partially restrict (or “throttle”) the flow of production 121 from the wellbore 120, and production valve 132 may be fully closed to fully restrict (or “block”) the flow of production 121 from the wellbore 120, and through the well surface system 124.

Keeping with FIG. 1, in some embodiments, the well surface system 124 includes a surface sensing system 134. The surface sensing system 134 may include sensors for sensing characteristics of substances, including production 121, passing through or otherwise located in the well surface system 124. The characteristics may include, for example, pressure, temperature, and flow rate of production 121 flowing through the wellhead 130, or other conduits of the well surface system 124, after exiting the wellbore 120.

In some embodiments, the surface sensing system 134 includes a surface pressure sensor 136 operable to sense the pressure of production 121 flowing through the well surface system 124, after it exits the wellbore 120. The surface pressure sensor 136 may include, for example, a wellhead pressure sensor that senses a pressure of production 121 flowing through or otherwise located in the wellhead 130. In some embodiments, the surface sensing system 134 includes a surface temperature sensor 138 operable to sense the temperature of production 121 flowing through the well surface system 124, after it exits the wellbore 120. The surface temperature sensor 138 may include, for example, a wellhead temperature sensor that senses a temperature of production 121 flowing through or otherwise located in the wellhead 130, referred to as “wellhead temperature” (T). In some embodiments, the surface sensing system 134 includes a flow rate sensor 139 operable to sense the flow rate of production 121 flowing through the well surface system 124, after it exits the wellbore 120. The flow rate sensor 139 may include hardware that senses a flow rate of production 121 (Q) passing through the wellhead 130.

In some embodiments, the well system 106 includes a reservoir simulator 160. For example, the reservoir simulator 160 may include hardware and/or software with functionality for generating one or more reservoir models regarding the hydrocarbon-bearing formation 104 and/or performing one or more reservoir simulations. For example, the reservoir simulator 160 may store well logs and data regarding core samples for performing simulations. A reservoir simulator may further analyze the well log data, the core sample data, seismic data, and/or other types of data to generate and/or update the one or more reservoir models. While the reservoir simulator 160 is shown at a well site, embodiments are contemplated where reservoir simulators are located away from well sites. In some embodiments, the reservoir simulator 160 may include a computer system that is similar to the computer system (the computer 902) described below with regard to FIG. 9 and the accompanying description.

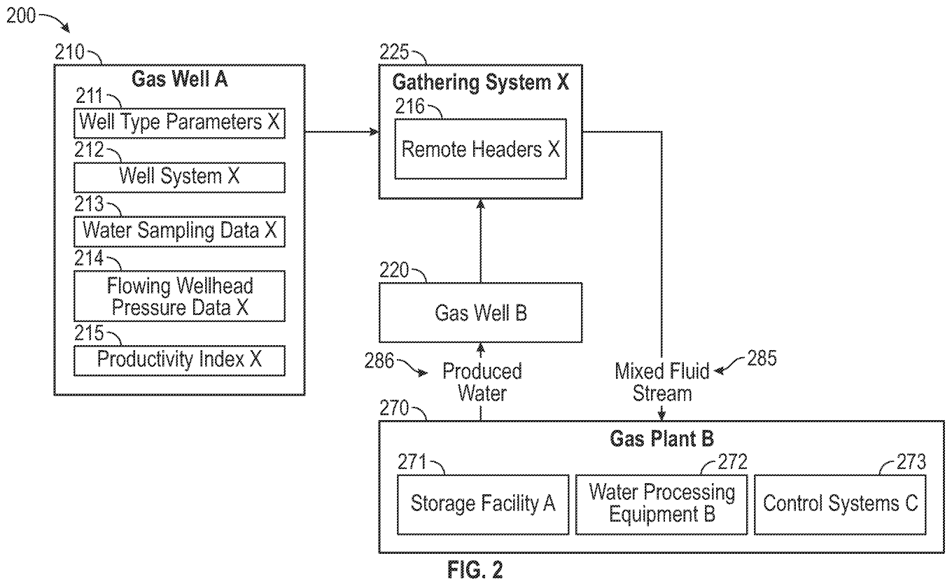

FIG. 2 shows a schematic diagram in accordance with one or more embodiments. As shown in FIG. 2, a gas production network (e.g., gas production network A 200) may include various gas wells (e.g., gas well A 210, gas well B 220), various gas plants (e.g., gas plant B 270), various control systems (e.g., control systems C 273), various network elements (not shown), and/or a gas supply manager (not shown). A gas well may include a well system (e.g., well system X 212) that is similar to well system 106 described above in FIG. 1 and the accompanying description. In some embodiments, various types of gas well data are collected over the gas production network, such as water sampling data (e.g., water sampling data X 213), flowing wellhead pressure data (e.g., flowing wellhead pressure data X 214), productivity index information (e.g., productivity index X 215). Likewise, the gas production network may also collect various well type parameters (e.g., well type parameters X 211) that describe various gas well characteristics, such as reservoir type, completion type, and surface facility conditions.

In some embodiments, one or more gas wells are coupled to a gathering system (e.g., gathering system X 225). A gathering system (also referred to as a collecting system or gathering facility) may include various hardware arrangements that connect flowlines from several gas wells into a single gathering line. For example, a gathering system may include flowline networks, headers, pumping facilities, separators, emulsion treaters, compressors, dehydrators, tanks, valves, regulators, and/or associated equipment. In particular, a remote header (e.g., remote headers X 216) may have production valves and testing valves to control a mixed stream for a flowline of a respective gas well. Thus, a gathering system may direct various hydrocarbon fluids to a processing or testing facility, such as a gas plant. In some embodiments, a gathering system manages individual fluid ratios (e.g., a particular gas-to-water ratio or condensate-to-gas ratio) as well as supply rates of oil, gas, and water. For example, a gathering system may assign a particular production value or ratio value to a particular gas well by opening and closing selected valves among the remote headers and using individual metering equipment or separators. Furthermore, a gathering system may be a radial system or a trunk line system. A radial system may bring various flowlines to a single central header. In contrast, a trunk-line system may use several remote headers to collect oil and gas from fields that cover a large geographic area. Once collected, the gathering system may transport and control the flow of oil or gas to a storage facility, a gas processing plant, or a shipping point.

Keeping with FIG. 2, gas may be transported from one or more gas wells (e.g., gas well A 210) to one or more gas plants (e.g., gas plant B 270), such as through one or more mixed fluid streams (e.g., mixed fluid stream 285). More specifically, a gas plant may refer to various types of industrial plants such as a gas processing plant, a gas cycling plant, or a compressor plant. A gas processing plant (also referred to as a natural gas processing plant) may be a facility that processes natural gas to recover natural gas liquids (e.g., condensate, natural gasoline, and liquefied petroleum gas) and sometimes other substances such as sulfur. A gas cycling plant may refer to an oilfield installation coupled to a gas-condensate reservoir. In particular, a gas cycling plant may extract various liquids from natural gas. Consequently, the remaining dry gas may be compressed prior to return to a producing formation, e.g., to maintain reservoir pressure. Moreover, various components of natural gas may be classified according to their vapor pressures, such as low pressure liquid (i.e., condensate), intermediate pressure liquid (i.e., natural gasoline), and high pressure liquid (i.e., liquefied petroleum gas). Examples of natural gas liquids include propane, butane, pentane, hexane, and heptane. With respect to compressor plants, a compressor plant may be a facility that includes multiple compressors, auxiliary treatment equipment, and pipeline installations for pumping natural gas over long distances. A compressor station may also repressurize gas in large gas pipelines or to link offshore gas fields to their final terminals.

Referring to gas plants more generally, a gas plant may include water processing equipment (e.g., water processing equipment B 272) that includes hardware and/or software for extracting, treating, and/or disposing of water associated with gas processing. More specifically, a gas plant may extract produced water (e.g., produced water 286) during the separation of oil or gas from a mixed fluid stream (e.g., mixed fluid stream 285) acquired from a gas well. This produced water may be a kind of brackish and saline water brought to the surface from underground formations. In particular, oil and gas reservoirs may have water in addition to hydrocarbons in various zones underneath the hydrocarbons, and even in the same zone as the oil and gas. However, most produced water is of very poor quality and may include high levels of natural salts and minerals that have dissociated from geological formations in the target reservoir. Likewise, produced water may also acquire dissolved constituents from fracturing fluids (e.g., substances added to the fracturing fluid to help prevent pipe corrosion, minimize friction, and aid the fracking process). However, through various water treatments, produced water may be reused in one or more gas wells, e.g., through waterflooding where produced water is injected into the reservoirs. By injecting produced water into an injection well, the injected water may force oil and gas to one or more production wells.

Referring to produced water more generally, a gas plant may use various treatment technologies in order to reuse or dispose of produced water, such as conventional treatments and advanced treatments. For example, conventional treatments may include flocculation, coagulation, sedimentation, filtration, and lime softening water treatment processes. Thus, conventional treatment processes may include functionality for removing suspended solids, oil and grease, hardness compounds, and other nondissolved water components. With advanced treatment technologies, water processing equipment may include functionality for performing reverse osmosis membranes, thermal distillation, evaporation and/or crystallization processes. These advanced treatment technologies may treat dissolved solids, such as chlorides, salts, barium, strontium, and sometimes dissolved radionuclides. In some embodiments, produced water is sent to a wastewater treatment plant that is equipped to remove barium and strontium, e.g., using sulfate precipitation. Outside of treatments for reusing produced water, water processing equipment may dispose of produced water using various water management options. For example, produced water may be disposed in salt water wells. Likewise, produced water may also be eliminated through a deep well injection.

In some embodiments, a gas plant may include one or more storage facilities (e.g., storage facility A 271) and one or more of control systems (e.g., control systems C 273). For example, different forms of gas may be stored in various storage facilities that include surface containers as well as various underground reservoirs, such as depleted gas reservoirs, aquifer reservoirs and salt cavern reservoirs. With respect to control systems, a control system may include hardware and/or software that monitors and/or operates equipment, such as at a gas well or in a gas plant. Examples of control systems may include one or more of the following: an emergency shut down (ESD) system, a safety control system, a video management system (VMS), process analyzers, other industrial systems, etc. In particular, a control system may include a programmable logic controller that may control valve states, fluid levels, pipe pressures, warning alarms, pressure releases and/or various hardware components throughout a facility. Thus, a programmable logic controller may be a ruggedized computer system with functionality to withstand vibrations, extreme temperatures, wet conditions, and/or dusty conditions, such as those around a refinery or drilling rig.

With respect to distributed control systems, a distributed control system may be a computer system for managing various processes at a facility using multiple control loops. As such, a distributed control system may include various autonomous controllers (such as remote terminal units) positioned at different locations throughout the facility to manage operations and monitor processes. Likewise, a distributed control system may include no single centralized computer for managing control loops and other operations. On the other hand, a SCADA (supervisory control and data acquisition) system may include a control system that includes functionality for enabling monitoring and issuing of process commands through local control at a facility as well as remote control outside the facility. With respect to a remote terminal unit (RTU), an RTU may include hardware and/or software, such as a microprocessor, that connects sensors and/or actuators using network connections to perform various processes in the automation system.

Referring to such control systems more generally, a control system may be coupled to facility equipment. Facility equipment may include various machinery such as one or more hardware components that may be monitored using one or more sensors. Examples of hardware components coupled to a control system may include crude oil preheaters, heat exchangers, pumps, valves, compressors, loading racks, and storage tanks among various other types of hardware components. Hardware components may also include various network elements or control elements for implementing control systems, such as switches, routers, hubs, PLCs, remote terminal units, user equipment, or any other technical components for performing specialized processes. Examples of sensors may include pressure sensors, torque sensors, rotary switches, weight sensors, position sensors, microswitches, hydrophones, accelerometers, etc. A gas supply manager, user devices, and network elements may be computer systems similar to the computer system (the computer 902) described in FIG. 9 and the accompanying description.

In some embodiments, a gas production network includes a gas supply manager (e.g., gas supply manager) that includes hardware and/or software for collecting data in real-time from various gas wells, gas plants, user devices, and other systems in the gas network. More specifically, a gas supply manager may include functionality for obtaining data throughout the gas production network, such as gas well data. For example, gas well data may include testing data of potential gas rates, flowing wellhead pressure (FWHP), water-gas ratio (WGR) data, condensate data such as condensate-gas ratio (CGR) data, productivity index (PI) data, water sampling data (e.g., levels of Chloride and Strontium concentrations), and congestion data regarding congestion cycles of gas wells. The gas supply manager may also collect various well type parameters (e.g., well type parameters X 211) regarding various gas wells, such as reservoir type, completion type, and remote header information regarding the gathering system coupled to the gas wells.

In some embodiments, a gas supply manager includes functionality for determining and/or implementing one or more production scenarios in real-time based on gas well data, well type parameters, and/or gas plant data. In particular, a production scenario may allocate different supply rates (e.g., by assigning a maximum production rate for a particular well) to different gas wells, different reservoirs, and/or different fields. As such, a gas supply manager may analyze multiple gas wells to cluster the gas wells based on various well parameters, real-time well potentials, peak summer production (PSP) automation, and/or different production scenarios. Moreover, the gas supply manager may determine well potential values for individual gas wells, as well as field potential values based on well potentials for multiple wells in a single field. Thus, the gas supply manager may automatically prioritize production instantaneously by incorporating various time-dependent gas and condensate demand scenarios into a production scenario. For example, the gas supply manager may analyze many aspects related to well production dynamics such as well productivity, supply demands, condensate yields, water analysis, solids production, as well as congestion cycles. Thus, the gas supply manager automatically generates and implements a production scenario as well as implements prioritization among various gas wells. In some embodiments, a gas supply manager includes functionality for generating periodic production scenarios, such as monthly scenarios.

In some embodiments, a user device may communicate with the gas supply manager to adjust dynamically a particular production scenario based on one or more user selections. The user device may be a personal computer, a handheld computer device such as a smartphone or personal digital assistant, or a human machine interface (HMI). For example, a user may interact with a user interface to change a time interval of a production period, the amount of solids and produced water mitigated in a production scenario, scenario parameters to maintain reservoir health, and amounts of water encroachment in a reservoir. Through user selections or automation, the gas supply manager may maintain well performance health, manage production in congested areas, and raise supply dynamic awareness by presenting well clusters and associated information in a graphical user interface. As such, a gas supply manager may provide agility and flexibility in determining and modifying production scenarios.

In some embodiments, a production scenario is generated by a gas supply manager upon obtaining a request from a user device and using various predetermined criteria such as reservoir pressure criteria and water risk criteria. The request may be a network message transmitted between a user device and a gas supply manager that identifies various gas wells, gas plants, gathering systems, a predetermined time frame, and other parameters for a requested production scenario. In some embodiments, the gas supply manager includes functionality for transmitting commands to one or more control systems to implement a particular production scenario. For example, the gas supply manager may transmit a network message over a machine-to-machine protocol to the well system X 212 in gas well A 210 or one or more of control systems C 273 in gas plant B 270. A command may be transmitted periodically, based on a user input, or automatically based on changes in gas well data or gas plant data.

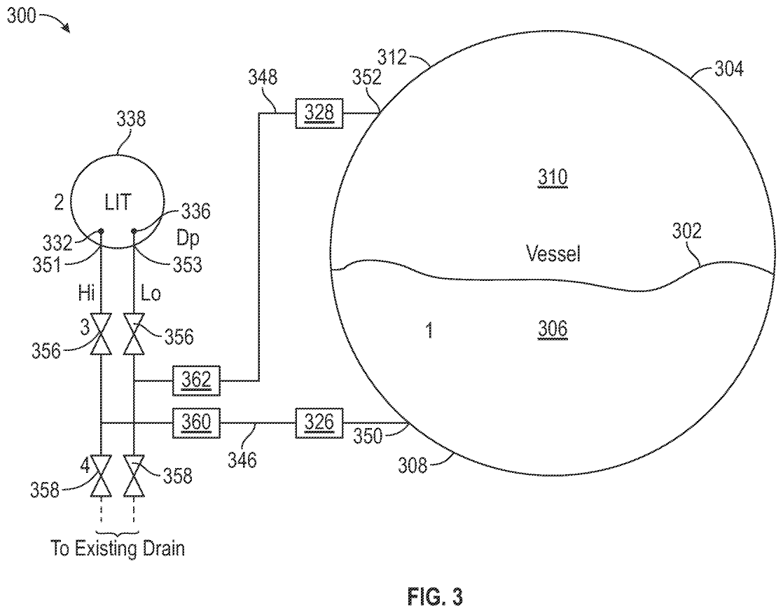

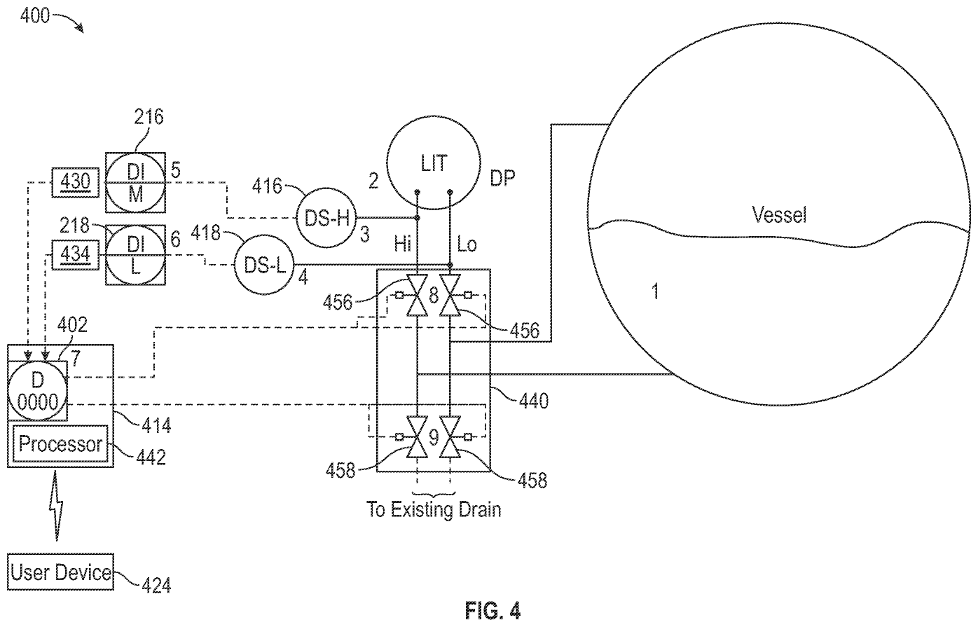

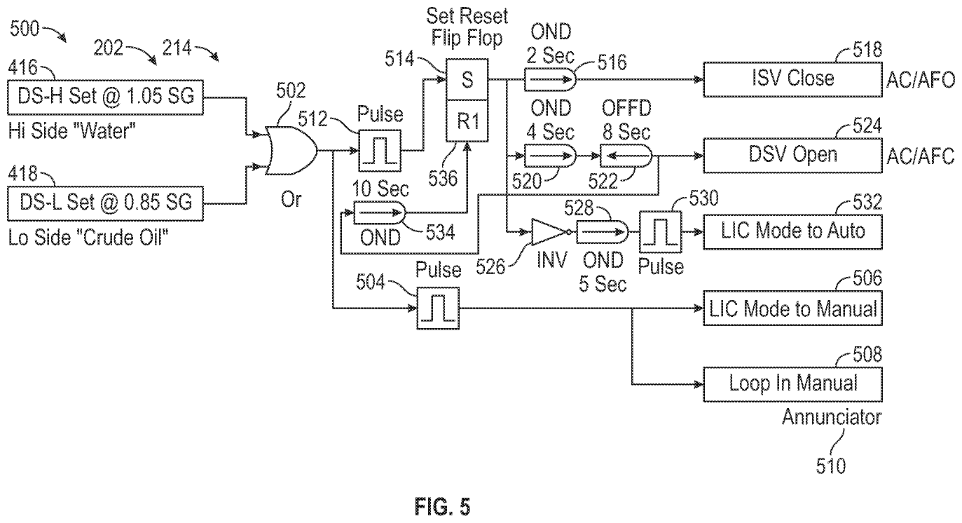

FIG. 3. FIG. 4, and FIG. 5 show schematic diagrams in accordance with one or more embodiments. FIG. 3 shows a system 300 in accordance with one or more embodiments. System 300 may be used to measure an interface level 302 of a vessel 304 containing a high-density immiscible fluid 306 in a vessel high side 308 and a low-density immiscible fluid 310 in a vessel low side 312. The term “high” refers to high pressure caused by higher-density fluid. Higher-density fluid may be located at a vertical distance lower than a low-density fluid. Thus, the vessel high side 308 is at a lower elevation than the vessel low side 312.

FIG. 3 shows the typical setup for the DP interface level application in SGPD GOSPs. The DP transmitter (a differential pressure transmitter 338) is connected by two process impulse lines of a hydraulic circuit in hydraulic communication with the vessel 304. The differential pressure transmitter 338 is configured to determine the interface level 302. The process impulse lines include a high side (HI) (a first impulse line 346) and a low side (LO) (a second impulse line 348). The first impulse line 346 may hydraulically couple the vessel high side 308 to a transmitter high side 332. The second impulse line 348 may hydraulically couple the vessel low side 312 to a transmitter low side 336. The first impulse line 346 may be coupled to the vessel high side 308 at a first line vessel end 350. The second impulse line 348 may be coupled to the vessel low side 312 at a second line vessel end 352. The first impulse line 346 may be coupled to the transmitter high side 332 at a first line sensor end 351. The second impulse line 348 may be coupled to the transmitter low side 336 at a second line sensor end 353. In this manner, the first line sensor end 351 and the second line sensor end 353 may cooperate to provide a differential pressure between the vessel high side 308 and the vessel low side 312.

The hydraulic circuit may include a pair of manual isolation valves (one or more of a manual isolation valve 356) configured to isolate the DP transmitter for any maintenance work. A pair of manual drain valves (one or more of a manual drain valve 358) are used to flush the hydraulic circuit if required. A flushing medium may be used to flush the impulse lines. Flushing the first impulse line 346 may include use of a first flushing medium. Likewise, flushing the second impulse line 348 may include use of a second flushing medium. At least one of the manual drain valve 358 may be hydraulically coupled with a valve manifold. In use at least one manual drain valve may be opened to drain a part or all of the hydraulic circuit.

A first impulse line fluid 326 within the first impulse line 346 may become contaminated over time to form a mixed high-density fluid 360. Likewise a second impulse line fluid 328 within the second impulse line 348 may become contaminated over time to form a mixed low-density fluid 362. The mixed high-density fluid 360 may not accurately reflect the characteristics, qualities, and viscosity of the high-density immiscible fluid 306. Likewise the mixed low-density fluid 362 may not accurately reflect the characteristics, qualities, and viscosity of the low-density immiscible fluid 310. Flushing the mixed fluids from the hydraulic circuit may rehabilitate the fluids disposed within the impulse lines.

FIG. 4 shows a schematic of a density monitoring system 400 in accordance with one or more embodiments. FIG. 4 shows that both process impulse lines are in hydraulic communication with the DP transmitter (differential pressure transmitter 338) and are also in hydraulic communication with two density sensors. The first density sensor for the high side process impulse line (DS-H) (density sensor-high, e.g., a first density sensor 416) is communicably coupled to vessel high side 308 to measure the fluid density of the relatively high-pressure side of the vessel, e.g., “water.” The second density sensor for the low side process impulse line (DS-L) (density sensor-low, e.g., a second density sensor 418) is communicably coupled to vessel low side 312 to measure the fluid density of the relatively low-pressure side of the vessel, e.g., “crude oil.”

The density DI-H (a density input high 417) and DI-L (a density input low 419) represent input parameters used in computer instructions for causing a processor 442 to carry out a flushing method. The computer instructions may be performed by a DCS logic 402. The DCS logic 402 may in turn control and maintain the quality of fluid inside the impulse lines by controlling the close/open action of isolation solenoid valves (each of an isolation solenoid valve 456). The first density sensor 416 may determine a first density 430 in proximity to the transmitter high side 332. The density input high 417 may provide the first density 430 of the high-density immiscible fluid 306 and may transmit the first density 430 to a controller 414. The second density sensor 418 may determine a second density 434 in proximity to the transmitter low side 336. The density input low 419 may provide the second density 434 of the low-density immiscible fluid 310 and may transmit the second density 434 to the controller 414.

DCS logic 402 will also control the open/close action of drainage solenoid valves (each one of a drainage solenoid valve 458). One or more of isolation solenoid valve 456 and/or one or more of drainage solenoid valve 458 may be hydraulically coupled with a valve manifold 440. The DCS logic 402 may be incorporated in a control system and/or a control panel (hereafter, the controller 414.) The control system may include a computer system that is the same as or similar to that of the computer system shown in FIG. 9 (computer 902) and the accompanying description. The controller 414 may include a processor 442. A user device 424 may be communicably coupled to the controller 414.

Controller 414 may include the computer instructions for causing the processor 442 to carry out the flushing method. The flushing method may be used for controlling the valve manifold using the first set of operational parameters and the second set of operational parameters. The computer instructions and/or the processor 442 may be disposed in the controller 414. The flushing method may include using the flushing medium to flush the impulse lines. The flushing medium may include, for example, a solvent, a surfactant, a detergent, an acid, a scale remover, a corrosion inhibitor, an amine inhibitor, etc. Flushing the first impulse line 346 may include use of the first flushing medium. Likewise, flushing the second impulse line 348 may include use of the second flushing medium. For example, the first flushing medium may be water and the second flushing medium may be crude oil or a petroleum-based solvent such as mineral spirits. The flushing method may include refilling the first impulse line 346 with a medium such as first impulse line fluid 326. Likewise, the flushing method may include refilling the second impulse line 348 with a medium such as second impulse line fluid 328.

The controller may use data input such as a first set of operational parameters and a second set of operational parameters and compare those with at least one of a predetermined criterion. For example, the first set of operational parameters may comprise one or more density readings. The second set of operational parameters may comprise the control settings such as reference densities. The controller may compare those data to each other. The controller may determine a calculated density differential using first density 430 and the second density 434. In this manner, the controller determines a fluid quality. The controller may determine that the fluid quality fails to satisfy at least one of the predetermined criterion. The controller may send a command to the valve manifold as a response to the comparing. If the controller determines that the fluid quality fails to satisfy the predetermined criterion, then the controller may command the valve manifold to perform a fluid rehabilitation method such as closing one or more of the isolation solenoid valve 456 and opening one or more of the drainage solenoid valve 458. In like manner, the controller 414 may determine the fluid quality of the first impulse line fluid 326 and/or of the second impulse line fluid 328.

FIG. 5 shows the control logic diagram 500 as used in the DCS logic 402. In a representative embodiment, the density sensor DS-H, i.e., first density sensor 416 for the high side, may be set, for example, at (+/−) 5% of 1.05 specific gravity of water. The density sensor DS-L, i.e., second density sensor 418 for the low side, may be set, for example, at (+/−) 5% of 0.85 specific gravity of crude oil. In operation of the DCS logic 402, if either input (DS-H) or (DS-L) is true, then the signal will go through an OR gate 502 thereby triggering a pulse 504 to change the LIC (level indicator controller) to manual 506, i.e., an interface level control loop (a control loop 508) will be operated in manual mode “MAN.” The signal will also initiate an annunciator 510 to console operator (such as the user device 424) alerting that the LIC mode is in manual mode “MAN.” The same signal out of the OR gate 502 through a pulse 512 will be an input true=(1) to the (set reset (SR) flip-flop) (an SR flip-flop 514), the output of which, (an SR output true 537) will be used as three true inputs:
(1) The first input true=(1) CLOSE will be sent through OND (an on delay timer 516) to ISV (isolation solenoid valve 518). The on delay timer 516 may be set, for example, for two seconds to close the ISV. The ISV actuation is set as air to close/air failure open (AC/AFO);
(2) The second input true=(1) will be sent to an OND (an on delay timer 520). Delay timer 520 may be set, for example, for four seconds to allow the ISV to be fully closed. Then the signal proceeds to an OFFD (an off delay timer 522). The off delay timer 522 may be set, for example, for eight seconds. Off delay timer 522 will received true=(1) thereby initiating true=(1) signal to open DSV (a drain solenoid valve 524), the mode of which is set as air to open/air failure close (AO/AFO). The signal to open drain solenoid valve 524 may include controlling the valve manifold 440 to open at least one drain valve hydraulically coupled with the valve manifold 440.
(3) The third input true=(1) will be sent to an inverter 526. Third input true=(1) is inverted to a zero, thus false=(0). In the output of inverter 526 is true=(1), then the third input signal goes to OND (an on delay timer 528). On delay timer 528 may be set, for example, for five seconds. The signal then continues to a pulse 530, then to LIC (level indicator controller 532) to switch mode to automatic mode “AUTO.” However, in this case the third input is inverted to a zero (0) thereby preventing switching the mode of LIC to “AUTO.”

The output signal from OFFD 8 (the off delay timer 522 set to, in this example, eight seconds) goes to OND 10 (an on delay timer 534 set to a duration of, for example, ten seconds) to reset the R1 (SR flip-flop, a reset 536) to normal. SR flip-flop set to normal will set the output (an SR output false 538) to false=(0). Output of SR flip-flop set to false=(0) may do two functions and may make no change to a third function. SR flip-flop set to false=(0) will first open the ISV (isolation solenoid valve 518). SR flip-flop set to false=(0) will make no change to the state of DSV (drain solenoid valve 524). SR flip-flop set to false=(0) will be inverted (at the inverter 526) to true=(1) and the signal will be delayed, in this example, for five seconds at on delay timer 528 to make sure the isolation solenoid valve 518 is fully open and that the impulse lines fluids are refreshed. The signal then proceeds to the pulse 530. Pulse 530 will switch the level indicator controller 532 mode to “AUTO.”

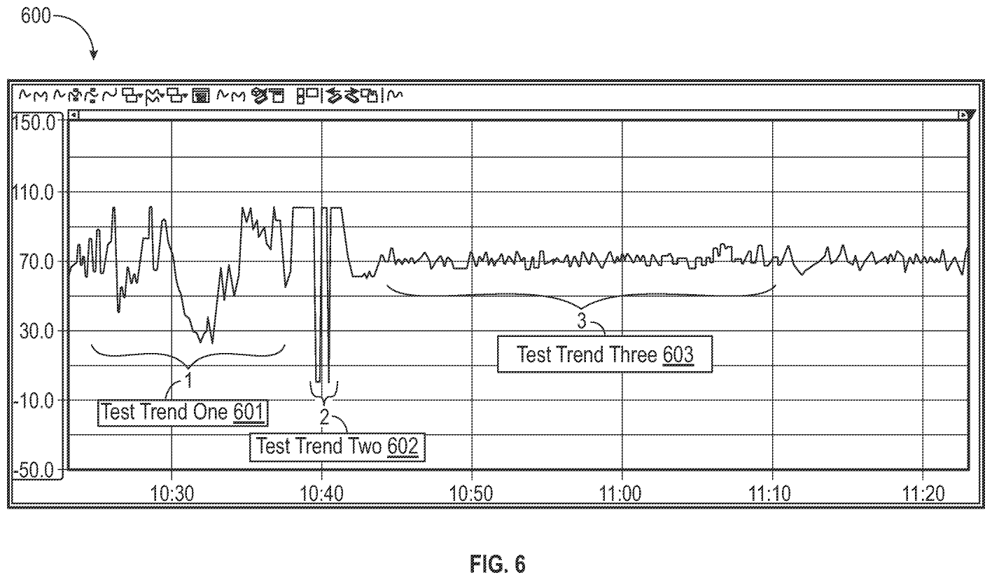

FIG. 6 shows the results of a lab test (lab test results 600) of the embodiments disclosed herein. FIG. 6 shows in trend {1} (a test trend one 601) the problem that this disclosure may remedy. Trend {2} (a test trend two 602) illustrates the flushing process. Trend {3} (a test trend three 603) illustrates a relatively stable level indicator signal that may indicate that the level indicator has stabilized, i.e., that the problem has been solved. In the trend marked {1}, the level indicates an upset in the process as evidenced by the relatively large swings in amplitude occurring over relatively short periods of time. The trend in {1} shows unrealistic amplitude swings, the large swings thereby affirming the interface real level upset. The large swings in amplitude may not happen in the indicated relatively small period of time because the size of trap (i.e., the very large size of the vessel 304) reduces such behavior. The flushing process {2} will act automatically and immediately or soon after activation to refresh the media in impulse lines. Trend marked {3} shows that the level has returned to normal.

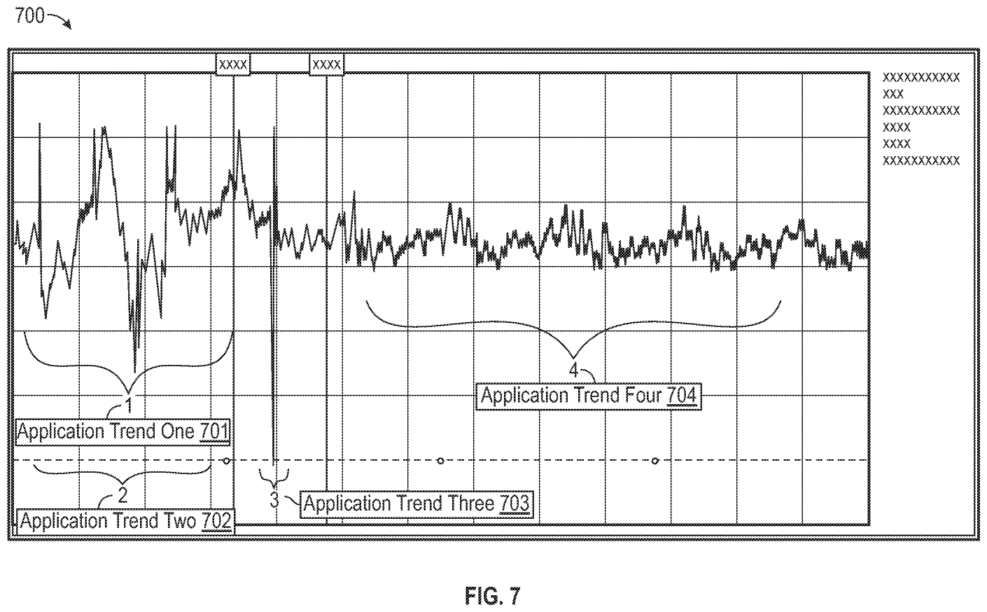

FIG. 7 shows the results of use of the embodiments disclosed herein. An application result 700 illustrates in trend {1} (an application trend one 701) the problem that this disclosure may remedy. The application is that of a PI trend (plant information trend) situation of UGOSP-7 (Uthmaniya-region gas-oil separation plant) level indicator controller LIC-3010 from South Ghawar Producing Department (SGPD.) The level starts indicating an above-normal level upset as highlighted in trend {1} (the application trend one 701) due to impulse line fluids deficiency. Trend {2} (an application trend two 702) shows that the operator (user) starts to override the controller mode to manual. Trend {3} (an application trend three 703) shows a flushing for both impulse lines results in a refreshing or rehabilitating of the fluids of the impulse lines. Trend {4} (an application trend four 704) shows bringing the level controller back to the normal reading in trend {4}. In some embodiments, the process upset duration may be minimized, operator interference may be reduced, and the stability of the interface level measurement and control may be ensured.

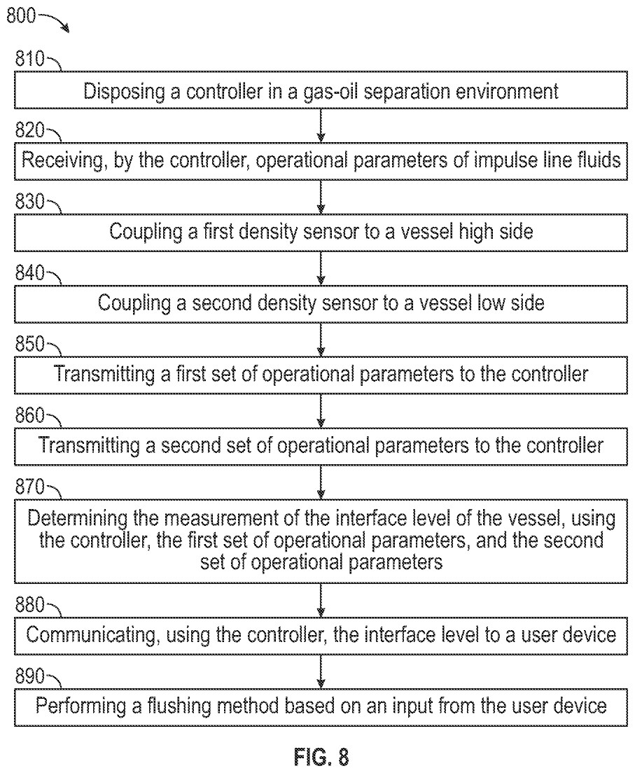

FIG. 8 depicts a flowchart of an example method (method 800) for a measurement of an interface level of a vessel containing a high-density immiscible fluid in a vessel high side and a low-density immiscible fluid in a vessel low side. Further, one or more steps in FIG. 8 may be performed by one or more components as described in FIGS. 1-5 (e.g., system 300). While the various steps in FIG. 8 are presented and described sequentially, one of ordinary skill in the art will appreciate that some or all of the steps may be executed in different orders, may be combined or omitted, and some or all of the steps may be executed in parallel. Furthermore, the steps may be performed actively or passively.

Referring to FIGS. 1-3 together, initially at step 810 a controller 414 is disposed in a gas-oil separation environment such as a gas-oil separation plant.

At step 820, the controller 414 receives operational parameters of impulse line fluids. The impulse line fluids include a first impulse line fluid 326 disposed in the first impulse line 346 and a second impulse line fluid 328 disposed in a second impulse line 348.

At step 830, a first density sensor 416 is coupled to a vessel high side 308. The vessel high side 308 may contain high-density immiscible fluid 306. The first density sensor 416 may be hydraulically coupled to the vessel high side 308. At step 840, a second density sensor 418 is coupled to a vessel low side 312. The vessel low side 312 may contain low-density immiscible fluid 310. The second density sensor 418 may be hydraulically coupled to the vessel low side 312.

At step 850, a first set of operational parameters of the high-density immiscible fluid 306 is transmitted to the controller 414. At step 860, a second set of operational parameters of the low-density immiscible fluid 310 is transmitted to the controller 414. At step 870, the measurement of the interface level of the vessel is determined using the controller 414, the first set of operational parameters, and the second set of operational parameters.

At step 880, the interface level is communicated using the controller 414 to a user device 424. At step 890, a flushing method based on an input from the user device 424 is performed. Alternatively, in some embodiments, the controller may automatically control the performance of the flushing method based on the determination of the measurement of the interface level of the vessel and the operational parameters.

Embodiments may be implemented on a computer system. FIG. 9 is a block diagram of a computer 902 used to provide computational functionalities associated with described algorithms, methods, functions, processes, flows, and procedures as described in the instant disclosure, according to an implementation. Computer 902 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 902 may include a computer that includes an input device, such as a keypad, keyboard, touch screen, or other device that can accept user information, and an output device that conveys information associated with the operation of the computer 902, including digital data, visual, or audio information (or a combination of information), or a graphical user interface (GUI.)

The computer 902 can serve in a role as a client, a network component, a server, a database or other persistency, or any other component (or a combination of roles) of a computer for performing the subject matter described in the instant disclosure. The computer 902 is communicably coupled with a network 916. In some implementations, one or more components of the computer 902 may be configured to operate within environments, including cloud-computing-based, local, global, or other environment (or a combination of environments).

At a high level, the computer 902 is an electronic computing device operable to receive, transmit, process, store, or manage data and information associated with the described subject matter. According to some implementations, the computer 902 may also include or be communicably coupled with an application server, e-mail server, web server, caching server, streaming data server, business intelligence (BI) server, or other server (or a combination of servers).

The computer 902 can receive requests over network 916 from a client application (for example, executing on another computer 902) and responding to the received requests by processing the said requests in an appropriate software application. In addition, requests may also be sent to the computer 902 from internal users (for example, from a command console or by other appropriate access method), external or third-parties, other automated applications, as well as any other appropriate entities, individuals, systems, or computers.

Each of the components of the computer 902 can communicate using a system bus 904. In some implementations, any or all of the components of the computer 902, both hardware or software (or a combination of hardware and software), may interface with each other or the interface 906 (or a combination of both) over the system bus 904 using an application programming interface (API 912) or a service layer 914 (or a combination of the API 912 and service layer 914. The API 912 may include specifications for routines, data structures, and object classes. The API 912 may be either computer-language independent or dependent and refer to a complete interface, a single function, or even a set of APIs. The service layer 914 provides software services to the computer 902 or other components (whether or not illustrated) that are communicably coupled to the computer 902.

The functionality of the computer 902 may be accessible for all service consumers using this service layer. Software services, such as those provided by the service layer 914, provide reusable, defined business functionalities through a defined interface. For example, the interface may be software written in JAVA, C++, or other suitable language providing data in extensible markup language (XML) format or another suitable format. While illustrated as an integrated component of the computer 902, alternative implementations may illustrate the API 912 or the service layer 914 as stand-alone components in relation to other components of the computer 902 or other components (whether or not illustrated) that are communicably coupled to the computer 902. Moreover, any or all parts of the API 912 or the service layer 914 may be implemented as child or sub-modules of another software module, enterprise application, or hardware module without departing from the scope of this disclosure.

The computer 902 includes an interface 906. Although illustrated as a single one of the interface 906, more than one of the interface 906 may be used according to particular desires or implementations of the computer 902. The interface 906 is used by the computer 902 for communicating with other systems in a distributed environment that are connected to the network 916. Generally, the interface 906 includes logic encoded in software or hardware (or a combination of software and hardware) and operable to communicate with the network 916. More specifically, the interface 906 may include software supporting one or more communication protocols associated with communications such that the network 916 or interface's hardware is operable to communicate physical signals within and outside of the computer 902.

The computer 902 includes at least one of a computer processor 918. Although illustrated as a single one of the computer processor 918, two or more processors may be used according to particular desires or particular implementations of the computer 902. Generally, the computer processor 918 executes instructions and manipulates data to perform the operations of the computer 902 and any algorithms, methods, functions, processes, flows, and procedures as described in the instant disclosure.

The computer 902 also includes a memory 908 that holds data for the computer 902 or other components (or a combination of both) that can be connected to the network 916. For example, the memory 908 may include a database storing data and/or processing instructions consistent with this disclosure. Although illustrated as a single one of the memory 908, two or more memories may be used according to particular desires and/or implementations of the computer 902 and the described functionality. While memory 908 is illustrated as an integral component of the computer 902, in alternative implementations, memory 908 can be external to the computer 902.

The application 910 is an algorithmic software engine providing functionality according to particular desires and/or particular implementations of the computer 902, particularly with respect to functionality described in this disclosure. For example, application 910 can serve as one or more components, modules, applications, etc. Further, although illustrated as a single one of application 910, the application 910 may be implemented as more than one of the application 910 on the computer 902. In addition, although illustrated as integral to the computer 902, in alternative implementations, the application 910 can be external to the computer 902.

There may be any number of the computer 902 associated with, or external to, a computer system containing computer 902, each one of the computer 902 communicating over network 916. Further, the term “client,” “user,” and other appropriate terminology may be used interchangeably as appropriate without departing from the scope of this disclosure. Moreover, this disclosure contemplates that many users may use one of the computer 902, or that one user may use more than one of the computer 902.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed is:

1. A system for measurement of an interface level of a vessel containing a high-density immiscible fluid in a vessel high side and a low-density immiscible fluid in a vessel low side, the system comprising:
a controller disposed in a gas-oil separation environment and configured to receive operational parameters of impulse line fluids comprising:
a first impulse line fluid disposed in a first impulse line, and
a second impulse line fluid disposed in a second impulse line;
a first density sensor coupled to the vessel high side; and
a second density sensor coupled to the vessel low side;
wherein the first density sensor is configured to transmit a first set of operational parameters of the high-density immiscible fluid to the controller;
wherein the second density sensor is configured to transmit a second set of operational parameters of the low-density immiscible fluid to the controller; and
wherein the controller is configured to perform:
determining the measurement of the interface level of the vessel, using the first set of operational parameters and the second set of operational parameters,
communicating the interface level to a user device, and
executing a flushing method based on an input from the user device.

2. The system of claim 1, wherein:
the first set of operational parameters comprises operational parameters of the first impulse line fluid; and
the second set of operational parameters comprises operational parameters of the second impulse line fluid.

3. The system of claim 1, wherein:
the first density sensor is configured to perform:
determining a first density of the high-density immiscible fluid in proximity to a transmitter high side, and
transmitting the first density to the controller; and
the second density sensor is configured to perform:
determining a second density of the low-density immiscible fluid in proximity to a transmitter low side, and
transmitting the second density to the controller.

4. The system of claim 3,
wherein a differential pressure transmitter comprises the transmitter high side and the transmitter low side and is configured to determine the interface level;
wherein the transmitter high side is coupled to the vessel high side; and
wherein the transmitter low side is coupled to the vessel low side.

5. The system of claim 1, further comprising:
a valve manifold operatively connected to the controller and in hydraulic communication with the impulse line fluids; and
wherein the controller is configured to receive the first set of operational parameters and the second set of operational parameters;
wherein the controller comprises computer instructions for causing a processor to carry out the flushing method for controlling the valve manifold using the first set of operational parameters and the second set of operational parameters.

6. The system of claim 1, wherein:
the first impulse line is coupled to the vessel high side at a first line vessel end; and
the second impulse line is coupled to the vessel low side at a second line vessel end;
wherein a first line sensor end of the first impulse line and a second line sensor end of the second impulse line cooperate to provide a differential pressure between the vessel high side and the vessel low side.

7. The system of claim 3, wherein the controller determines a fluid quality inside a differential pressure transmitter using a calculated density differential using the first density and the second density.

8. The system of claim 5, wherein the controller is configured to perform:
comparing the first set of operational parameters and the second set of operational parameters with at least one of a predetermined criterion, and
sending a command to the valve manifold in response to the comparing failing to satisfy the at least one of the predetermined criterion.

9. The system of claim 5 wherein the controlling the valve manifold comprises opening at least one drain valve hydraulically coupled with the valve manifold.

10. A method for a measurement of an interface level of a vessel containing a high-density immiscible fluid in a vessel high side and a low-density immiscible fluid in a vessel low side, the method comprising:
disposing a controller in a gas-oil separation environment;
receiving, by the controller, operational parameters of impulse line fluids comprising:
a first impulse line fluid disposed in a first impulse line, and
a second impulse line fluid disposed in a second impulse line;
coupling a first density sensor to a vessel high side;
coupling a second density sensor to a vessel low side;
transmitting a first set of operational parameters of the high-density immiscible fluid to the controller;
transmitting a second set of operational parameters of the low-density immiscible fluid to the controller;
determining the measurement of the interface level of the vessel, using the controller, the first set of operational parameters, and the second set of operational parameters;
communicating, using the controller, the interface level to a user device, and
performing a flushing method based on an input from the user device.

11. The method of claim 10,
wherein determining the measurement of the interface level using the first set of operational parameters comprises using operational parameters of the first impulse line fluid; and
wherein determining the measurement of the interface level of the vessel using the second set of operational parameters comprises using operational parameters of the second impulse line fluid.

12. The method of claim 10,
wherein transmitting the first set of operational parameters to the controller comprises:
determining, using the first density sensor, a first density of the high-density immiscible fluid in proximity to a transmitter high side;
transmitting the first density to the controller; and
wherein transmitting the second set of operational parameters to the controller comprises:
determining, using the second density sensor, a second density of the low-density immiscible fluid in proximity to a transmitter low side, and
transmitting the second density to the controller.

13. The method of claim 12, further comprising:
determining the interface level using a differential pressure transmitter comprising the transmitter high side and the transmitter low side,
coupling the transmitter high side to the vessel high side; and
coupling the transmitter low side to the vessel low side.

14. The method of claim 10, wherein determining, using the first set of operational parameters and the second set of operational parameters, the interface level of the vessel further comprises:
operatively connecting, to the controller, and in hydraulic communication with the impulse line fluids, a valve manifold;
receiving, by the controller, the first set of operational parameters and the second set of operational parameters; and
performing, by the controller comprising computer instructions, the flushing method using the computer instructions, for controlling the valve manifold using the first set of operational parameters and the second set of operational parameters.

15. The method of claim 10 further comprising:
coupling the first impulse line to the vessel high side at a first line vessel end;
coupling the second impulse line to the vessel low side at a second line vessel end; and
using a first line sensor end and a second line sensor end to provide a differential pressure between the vessel high side and the vessel low side.

16. The method of claim 12 further comprising:
calculating a density differential using the first density and the second density; and
determining, using the controller and the density differential, a fluid quality inside a differential pressure transmitter.

17. The method of claim 14 further comprising:
comparing, using the controller, the first set of operational parameters and the second set of operational parameters with at least one of a predetermined criterion; and
sending a command, using the controller, to the valve manifold in response to the comparing failing to satisfy the at least one of the predetermined criterion.

18. The method of claim 14 wherein the controlling the valve manifold comprises opening at least one drain valve hydraulically coupled with the valve manifold.

19. The method of claim 17 wherein the sending the command further comprises:
changing a level control mode from an automatic mode to a manual mode;
draining the first impulse line fluid out of the first impulse line;
draining the second impulse line fluid out of the second impulse line;
flushing the first impulse line with a first flushing medium;
flushing the second impulse line with a second flushing medium;
refilling the first impulse line with the first impulse line fluid;
refilling the second impulse line with the second impulse line fluid; and
changing the level control mode from the manual mode to the automatic mode.
